(19) United States
(12) Patent Application Publication
(10) Pub. No.: US 2015/0100687 A1
(43) Pub. Date: Apr. 9, 2015

(54) CONTROL PROGRAM, CONTROL DEVICE, AND CONTROL METHOD

(71) Applicant: FUJITSU LIMITED, Kawasaki-shi (JP)

(72) Inventors: Tetsuya UCHIUMI, Kawasaki (JP); Shinya Kitajima, Inagi (JP); Shinji Kikuchi, Yokohama (JP); YASUHIDE MATSUMOTO, Kawasaki (JP); Toshihiro Kodaka, Yokohama (JP)

(21) Appl. No.: 14/495,833

(22) Filed: Sep. 24, 2014

(30) Foreign Application Priority Data
Oct. 4, 2013 (JP) 2013-209499

(51) Int. Cl. H04L 12/26; H04L 12/24

(52) U.S. Cl. CPC H04L 43/04; H04L 41/08
USPC 709/224

(57) ABSTRACT

In a control device, a relationship extracting module extracts, from specification-item change information indicative of change information concerning specification items of hardware changed in the past and parameter change information indicative of change information concerning parameters set to the hardware, combinations of the specification-item change information and the parameter change information being in correlation. A change-pattern generator calculates a relational expression of the specification-item change information and the parameter change information for each of the extracted combinations, and generates a change pattern of the parameter change information corresponding to the specification-item change information by the calculated relational expression.

### CROSS-REFERENCE TO RELATED APPLICATION

This application is based upon and claims the benefit of priority of the prior Japanese Patent Application No. 2013-209499, filed on Oct. 4, 2013, the entire contents of which are incorporated herein by reference.

### FIELD

The embodiment discussed herein is related to a control program, a control device, and a control method.

### BACKGROUND

In recent years, cloud systems have been available that leverage a virtualization technology in servers and networks, and allow a plurality of computing resources in a network to be used as a computing resource of a user. Such a cloud system is getting large-scaled and complicated, and changes in the system are made on a daily basis. For example, devices are added, and parameters concerning the design of the system are added or changed.

Following a request to change the system, designing of the system is conducted. In designing the system, a designer creates design rules. The design rules here are the rules to design parameters concerning the designing, and a design procedure is a collection of design rules arranged in the order of execution. Then, a device that automatically generates parameters generates, based on the design rules and the design procedure created, the parameters concerning the system to which the changes are made.

Furthermore, when changes in system configuration are made following the change request of the system, it is preferable to change the design rules. When the system configuration is complicated, however, it is difficult for the designer to change the design rules.

Consequently, known is a technology in which, following the changes in the device configuration in a domain, a rule managing device that can automatically change the design rules, for example (see Japanese Laid-open Patent Publication No. 2000-156712, for example). In such a technology, the rule managing device stores domain-independent rules, in which elements indicative of individual devices are isolated from rule information, in a database. The rule managing device then automatically changes the design rules from the device configuration information changed and the domain-independent rules stored in advance, in response to a device configuration change of each domain from a domain administrator.

In a large-scale system such as a cloud system, however, there may be situations in which the design rules are not changed automatically. For example, in a data center in the system, there may be situations in which the environment of usage is changed, or in which devices are replaced or added following a specification change. The specification change includes changes concerning the performance, as one example. In such a case, although it is preferable to change the design rules, the design rules are not changed automatically. More specifically, there are situations in which the design rules that correspond to the environmental changes and specification changes are not changed automatically.

### SUMMARY

According to an aspect of an embodiment, a non-transitory computer-readable recording medium stores therein a control program that causes a computer to execute a process. The process includes extracting, from specification-item change information indicative of change information concerning specification items of hardware changed in past and parameter change information indicative of change information concerning parameters set to the hardware, combinations of the specification-item change information and the parameter change information being in correlation. The process includes calculating a relational expression of the specification-item change information and the parameter change information for each of the combinations extracted at the extracting. The process includes generating a change pattern of the parameter change information corresponding to the specification-item change information by the relational expression calculated at the calculating.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a functional block diagram illustrating the configuration of a control device according to an embodiment;

FIG. 2 is a table illustrating an example of the data structure of specification information;

FIG. 3 is a table illustrating an example of the data structure of parameter information;

FIG. 4 is a diagram illustrating an example of a design rule;

FIG. 5 is a chart illustrating the tendency of change in parameter that follows a change in specification item;

FIG. 6A is a diagram (part 1) for explaining a relationship extracting module in the embodiment;

FIG. 6B is a diagram (part 2) for explaining the relationship extracting module in the embodiment;

FIG. 6C is a diagram (part 3) for explaining the relationship extracting module in the embodiment;

FIG. 7A is a diagram (part 1) for explaining a change-pattern generator in the embodiment;

FIG. 7B is a diagram (part 2) for explaining the change-pattern generator in the embodiment;

FIG. 7C is a diagram (part 3) for explaining the change-pattern generator in the embodiment;

FIG. 8 is a diagram for explaining a change-rule generator in the embodiment;

FIG. 9A is a diagram (part 1) for explaining a design-rule change module in the embodiment;

FIG. 9B is a diagram (part 2) for explaining the design-rule change module in the embodiment;

FIG. 9C is a diagram (part 3) for explaining the design-rule change module in the embodiment;

FIG. 9D is a diagram (part 4) for explaining the design-rule change module in the embodiment;

FIG. 9E is a diagram (part 5) for explaining the design-rule change module in the embodiment;

FIG. 9F is a diagram (part 6) for explaining the design-rule change module in the embodiment;

FIG. 9G is a diagram (part 7) for explaining the design-rule change module in the embodiment;

FIG. 10A is a flowchart (part 1) illustrating a design-rule change process performed in the embodiment;

FIG. 10B is a flowchart (part 2) illustrating the design-rule change process performed in the embodiment; and

FIG. 11 is a block diagram illustrating an example of a computer that executes a control program.

### DESCRIPTION OF EMBODIMENT

Preferred embodiments of the present invention will be explained with reference to accompanying drawings. The present invention, however, is not intended to be limited by the embodiment.

Configuration of Control Device

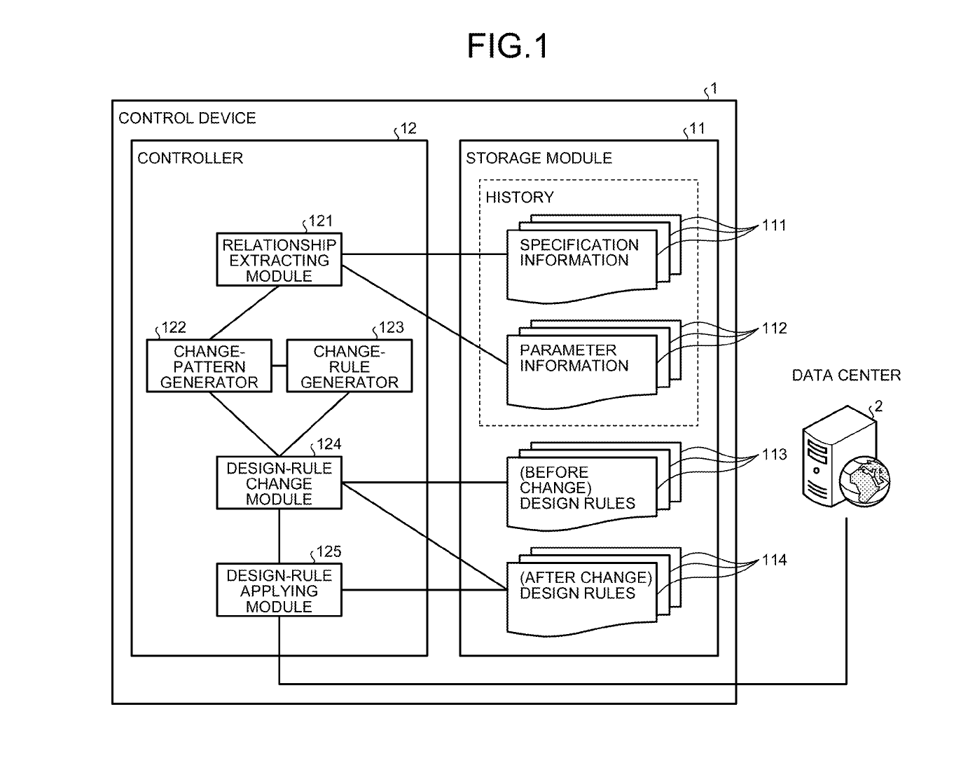

FIG. 1 is a functional block diagram illustrating the configuration of a control device according to an embodiment. Such a control device 1 controls the change of design rules, which are used in designing a data center or a server and the like installed in the data center, according to a design unit. The design unit here may be a unit of data center or a unit of server. If the design unit is a unit of data center, on a data center in a cloud system, for example, the control device 1 automatically changes the already-generated design rules when the usage environment is changed, or when the specification is changed. If the design unit is a unit of server, on a physical server in a data center, for example, the control device 1 automatically changes the already-generated design rules when the usage environment is changed, or when the server is replaced or added following the changes in specification. The design rule is a rule to set the value of a parameter concerning the designing. That is, the design rule is a rule to set the value of a parameter defined in a configuration file, for example.

When the design unit is a unit of data center, on the data center, the control device 1 extracts the specifications and parameters that are in correlation by using the change information on changed specifications and the change information on values set to the parameters at the time the specifications were changed in the past. The control device 1 then generates the tendency of change in the extracted specifications and parameters as a change pattern. Furthermore, when the design unit is a unit of server, on a server installed in a data center, the control device 1 extracts the specifications and parameters that are in correlation by using the change information on changed specifications and the change information on values set to the parameters at the time the specifications were changed in the past. The control device 1 then generates the tendency of change in the extracted specifications and parameters as a change pattern. The following describes in detail the control device 1 when the design unit is a unit of data center 2, as one example.

As illustrated in FIG. 1, the control device 1 includes a storage module 11 and a controller 12.

The storage module 11 corresponds to a storage device such as a non-volatile semiconductor memory device of a flash memory and a ferroelectric random access memory (FRAM, registered trademark), for example. The storage module 11 includes specification information 111, parameter information 112, design rules 113 before the change, and design rules 114 after the change.

The specification information 111 is, for example, the information concerning the performance of a data center, which includes the information on a network interface card (NIC), the information on the memory installed on a physical server, and the number of virtual machines (VMs) deployed in a physical server, as one example. The specification information 111 further includes the number of physical servers deployed in the data center, the total number of VMs deployed in the data center, the information on CPU, and the information on HDD. While the specification information 111 includes the information represented by a string of characters such as the information on the architecture of the CPU and the information on the model, it is assumed that the information represented by a string of characters is not handled here. More specifically, it is assumed that the specification information 111 handles the information represented by numerical values.

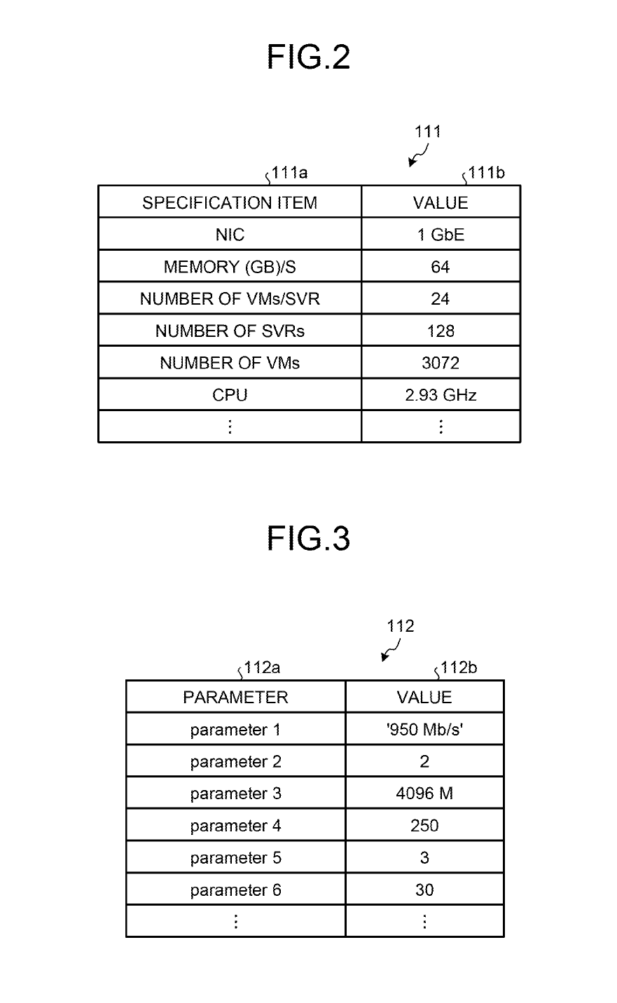

Now, the data structure of the specification information 111 will be described with reference to FIG. 2. FIG. 2 is a table illustrating an example of the data structure of the specification information. As illustrated in FIG. 2, the specification information 111 stores therein specification items 111a and values 111b being associated with each other. The specification item 111a represents the item name of specification item. The value 111b represents the value of the specification item 111a. As one example, when the specification item 111a is “NIC”, “1 GbE” is stored as the value 111b. Note that the specification items 111a are defined with the specification items for which the values 111b are of numerical values.

Referring back to FIG. 1, the parameter information 112 is the information on parameters concerning the designing, and includes the parameters and the values thereof. The parameter information 112 is defined for each physical server in the data center.

Now, the data structure of the parameter information 112 will be described with reference to FIG. 3. FIG. 3 is a table illustrating an example of the data structure of parameter information. As illustrated in FIG. 3, the parameter information 112 stores therein parameters 112a and values 112b being associated with each other. The parameter 112a represents the name of parameter. The value 112b represents the value of the parameter 112a. As one example, when the parameter 112a is “parameter1”, “‘950 Mb/s’” is stored as the value 112b.

Returning to FIG. 1, the specification information 111 and the parameter information 112 are each recorded in the storage module 11 as history each time a trigger occurs. The trigger includes the timing of newly structuring a data center, the timing of improving the performance of a server or the like in an already-structured data center, and the timing of adding a server or the like to an already-structured data center, for example. As one example, when the timing of newly structuring a data center is regarded as a trigger, the specification information 111 and the parameter information 112 of the newly structured data center are recorded in the storage module 11. When the timing of improving the performance of a server or the like in the already-structured data center is regarded as a trigger, the specification information 111 and the parameter information 112 of the data center that includes the server for which the performance is improved are recorded in the storage module 11.

The design rules 113 and 114 are the rules to set the values of the parameters concerning the designing to the data center. The design rules 113 are the design rules recorded at the timing of a trigger, and are referred to as before-change design rules. The design rules 114 are the design rules in which the before-change design rules were changed by a later-described design-rule change module 124, and are referred to as after-change design rules.

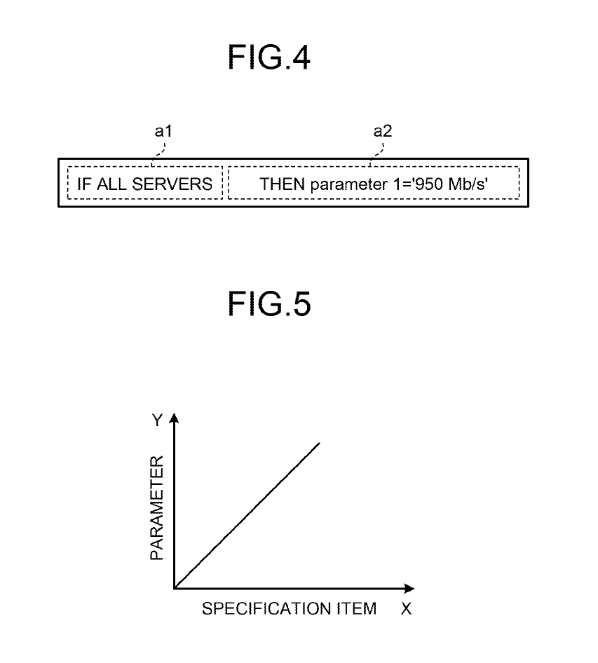

Now, an example of the design rules 113 and 114 will be described with reference to FIG. 4. FIG. 4 is a diagram illustrating one example of a design rule. As illustrated in FIG. 4, the design rules 113 and 114 include a condition a1 and a definition a2. The condition a1 represents the condition of a design rule. The definition a2 represents a parameter and a value thereof which are set when the condition a1 is satisfied. As one example, when the condition a1 is “all servers”, “parameter1=‘950 Mb/s’” is stored as the definition a2. The design-rule change module 124 described later changes the value of the parameter represented in the definition a2 in response to environmental changes and specification changes.

The controller 12 includes an internal memory to store therein programs that define procedures of various processes and control data, and executes the various processes with the foregoing. The controller 12 corresponds to an electronic circuit of an integrated circuit such as an application specific integrated circuit (ASIC) and a field programmable gate array (FPGA), for example. Alternatively, the controller 12 corresponds to an electronic circuit such as a central processing unit (CPU) and a micro processing unit (MPU). The controller 12 further includes a relationship extracting module 121, a change-pattern generator 122, a change-rule generator 123, the design-rule change module 124, and a design-rule applying module 125.

The relationship extracting module 121 extracts combinations of change information, in which specification items and parameters are in correlation, from the change information concerning the specification items of the data center changed in the past and the change information concerning the parameters set to the data center. The change information concerning the specification items here is referred to as “specification-item change information”, and the “specification-item change information” is present for each specification item. The “specification-item change information” includes a change scale of a value of a specification item. The change information concerning the parameters is referred to as “parameter change information”, and the “parameter change information” is present for each parameter. The “parameter change information” includes a change scale of a value of a parameter.

For example, the relationship extracting module 121 calculates, for each change, a change scale between the same specification items in two pieces of the specification information 111 before and after the change, for each specification item. The relationship extracting module 121 then generates, for each specification item, the specification-item change information between the two pieces of the specification information 111. Furthermore, the relationship extracting module 121 calculates, for each change, a change scale between the same parameters in two pieces of the parameter information 112 before and after the change, for each parameter. The relationship extracting module 121 then generates, for each parameter, the parameter change information between the two pieces of the parameter information 112.

The relationship extracting module 121 then extracts combinations of the parameter change information and the specification-item change information that are in correlation, from the specification-item change information and the parameter change information in the change information on a plurality of changes. As one example, the relationship extracting module 121 extracts round robin combinations of the specification-item change information and the parameter change information for the change information on each change. The relationship extracting module 121 then extracts, out of the extracted combinations, the combinations in which neither one of the change scales is one as “related”. The relationship extracting module 121 further extracts, out of the extracted combinations, the combinations in which either one of the change scales is one as “not related”. Then, the relationship extracting module 121 extracts, out of the extracted combinations, the combination in which “not related” is not present in the change information on any of the changes, as a combination of “related”. Furthermore, the relationship extracting module 121 excludes, out of the extracted combinations, the combination in which the “not related” is present in the change information on any of the changes as a combination of “not related”. The relationship extracting module 121 ignores the combination in which both change scales are one, as a combination of “unknown” for which whether the relationship is present is indeterminable.

The change-pattern generator 122 calculates a relational expression of the specification-item change information and the parameter change information for each combination extracted by the relationship extracting module 121. In other words, the change-pattern generator 122 generates a tendency that is common to each change, as a change pattern, for each combination extracted by the relationship extracting module 121. Now, the tendency of changes in parameters that follows a change in specification item will be described with reference to FIG. 5. FIG. 5 is a chart illustrating the tendency of change in parameter that follows a change in specification item. In FIG. 5, an X axis represents the change scale of the value of a specification item, and a Y axis represents the change scale of the value of a parameter. As illustrated in FIG. 5, when the value of a specification item is changed, the value of the parameter corresponding to the changed specification item is also changed. It is assumed here that the specification item and the parameter change linearly. In FIG. 5, it is illustrated that, when the CPU performance as a specification item is changed threefold, the value of the corresponding parameter also changes threefold, for example. More specifically, it can be expressed by a linear function of Y=aX (a is “1”, here). The linear function is not limited to only Y=aX, but may be Y=aX+b.

Referring back to FIG. 1, the change-pattern generator 122 calculates, for each combination extracted by the relationship extracting module 121, change ratios for the change scales of the specification items and parameters included in the change information on each change, for example. The change-pattern generator 122 then selects the combinations one by one, and on the selected combination, determines whether the change ratios for the respective changes are the same. If the change ratios for the respective changes on the selected combination are the same, the change-pattern generator 122 calculates, based on the change ratio, a linear function of the specification-item change information and the parameter change information. The change-pattern generator 122 then generates, by the calculated linear function, a change pattern of the parameter change information corresponding to the specification-item change information. As one example, when the specification item is “NIC” and the parameter is “parameter1” as a combination and the linear function is Y=X, the change pattern is generated as “IF NIC=n-fold THEN parameter1=n-fold”.

If the change ratios for the respective changes of the selected combination are not the same, the change-pattern generator 122 then generates a change rule which will be described later.

The change-rule generator 123 generates a change rule for the selected combination. More specifically, the change-rule generator 123 generates, for the selected combination, a rule (change rule) in which, when the value of the specification item is changed, the value of the parameter also needs to be changed. That is, in the combination in which the tendency of change is not constant, a change pattern is not generated although it is the combination of “related”. Thus, the change-rule generator 123 generates a change rule for the combination of “related” for which a change pattern is not generated.

For example, it is assumed that there is a tendency of being changed at the same time among the specification items. Under this assumption, the change-rule generator 123 extracts, by using the specification-item change information on each change, two specification items in which neither one of the change scales is one. More specifically, the change-rule generator 123 extracts two specification items that have the tendency of being changed at the same time among the specification items. Then, if the combination of one specification item, out of the two specification items extracted, and one parameter is the combination that has a change pattern, the change-rule generator 123 generates a change rule by using the parameter and the other specification item. The change rule is used for checking whether a design rule has been changed by the relation of the parameter and the other specification item.

The design-rule change module 124 changes the design rule that sets the value of the parameter corresponding to the change pattern by using the change pattern generated by the change-pattern generator 122 and the specification-item change information on the specification item to be changed this time. For example, the design-rule change module 124 reads out the design rule 113 that sets the value of the parameter corresponding to the change pattern generated by the change-pattern generator 122 from the storage module 11. The design-rule change module 124 then changes the read-out design rule 113 by using the change pattern generated by the change-pattern generator 122 and the specification-item change information on the specification item to be changed this time, and records the after-change design rule 114 in the storage module 11.

The design-rule change module 124 further checks, by using the change rule generated by the change-rule generator 123, whether the after-change design rule 114 was changed by the relation of the specification item and the parameter which correspond to the change rule.

The design-rule applying module 125 applies the after-change design rule 114, and based on the design rule 114, automatically designs the parameter.

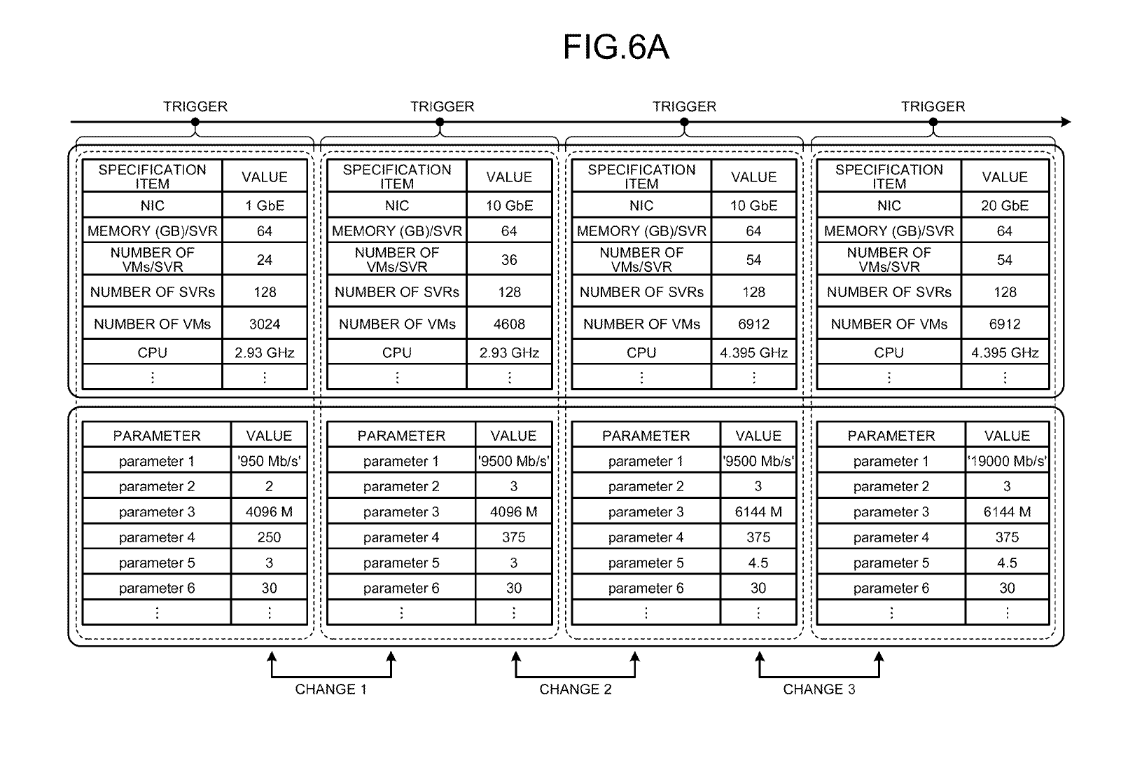

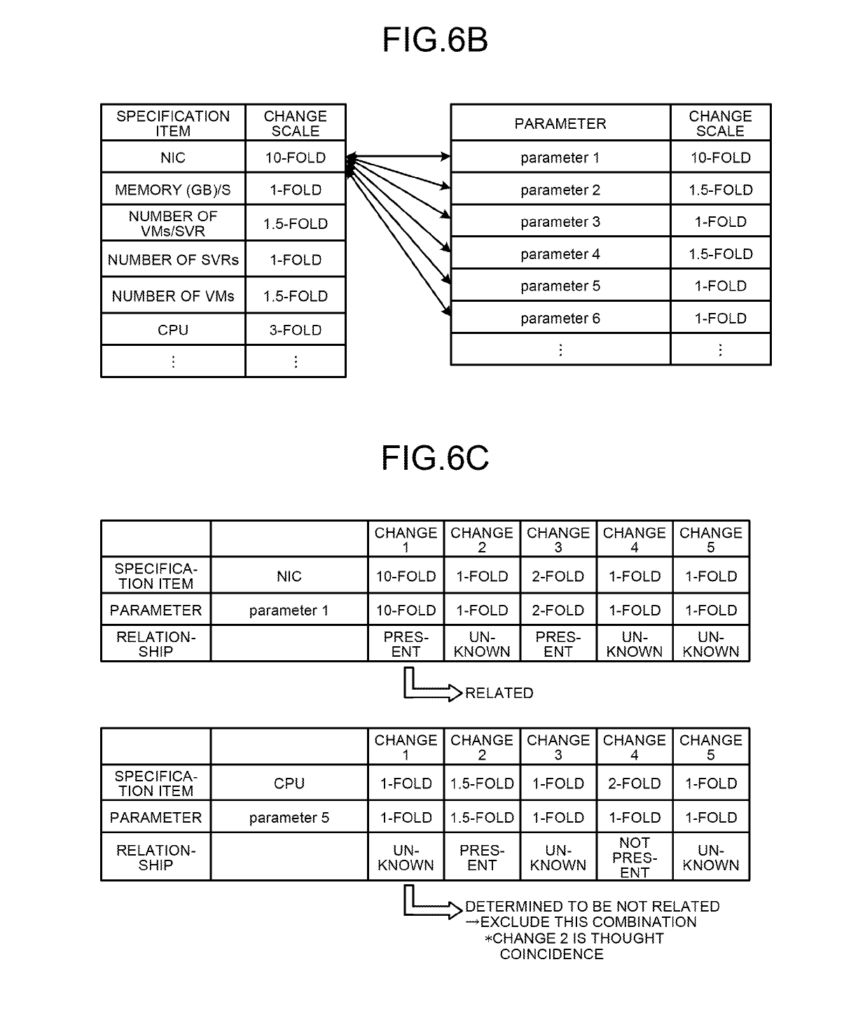

Next, the relationship extracting module 121 in the embodiment will be described with reference to FIGS. 6A to 6C. FIGS. 6A to 6C are diagrams for explaining the relationship extracting module in the embodiment. As illustrated in FIG. 6A, it is assumed that the specification information 111 and the parameter information 112 are recorded in the storage module 11 for each trigger. The relationship extracting module 121 then calculates, for each change, the change scales of the same specification items between the specification information 111 before and after the change and the change scales of the same parameters between the parameter information 112 before and after the change.

As illustrated on the left side in FIG. 6B, the change scales are indicated for the respective specification items. More specifically, the specification-item change information for each specification item is indicated for the change 1 (see FIG. 6A), for example. As illustrated on the right side in FIG. 6B, the change scales are indicated for the respective parameters. More specifically, the parameter change information for each parameter is indicated for the change 1 (see FIG. 6A), for example. Under such a condition, the relationship extracting module 121 extracts round robin combinations of the specification-item change information and the parameter change information for the change information on the change 1, for example. As one example, when the specification item is “NIC”, the respective parameters of “parameter1”, “parameter2”, “parameter3”, . . . , “PARAMETER6” are combined therewith. When the specification item is “Memory (GB)/S”, the respective parameters of “parameter1”, “parameter2”, “parameter3”, . . . , “PARAMETER6” are combined therewith.

The relationship extracting module 121 then extracts, out of the extracted combinations, the combinations in which neither one of the change scales is one as “related”. Here, the combination of “NIC” and “parameter1”, the combination of “NIC” and “parameter2”, and the combination of “NIC” and “Parameter4” are extracted as “related”, as one example.

The relationship extracting module 121 then extracts, out of the extracted combinations, the combinations in which either one of the change scales is one as “not related”. Here, the combination of “NIC” and “parameter3”, the combination of “NIC” and “parameter5”, and the combination of “NIC” and “PARAMETER6” are extracted as “not related”, as one example.

As illustrated in FIG. 6C, illustrated are the change scales for the respective changes in the combinations extracted by the relationship extracting module 121. The combination in the upper row is the combination of the specification item of “NIC” and the parameter of “parameter1”. In the combination of the upper row, the change scales are tenfold each in the change 1, and the combination is of “related”. In the change 3, the change scales are twofold each, and the combination is of “related”. In the other changes 2, 4, and 5, the change scales are one-fold each, and thus the combinations are of “unknown”. In this combination, because the “not related” is not present in the change information on any of the changes, the relationship extracting module 121 extracts it as a combination of “related”.

The combination in the lower row is the combination of the specification item of “CPU” and the parameter of “parameter5”. In the combination of the lower row, the change scales are one-and-a-half-fold each in the change 2, and the combination is of “related”. In the change 4, the change scale of the specification item is twofold and the change scale of the parameter is one-fold, and thus the combination is of “not related”. In the other changes 1, 3, and 5, the change scales are one-fold each, and thus the combinations are of “unknown”. In this combination, because the “not related” is present in the change information on the change 4, the relationship extracting module 121 excludes it as a combination of “not related”.

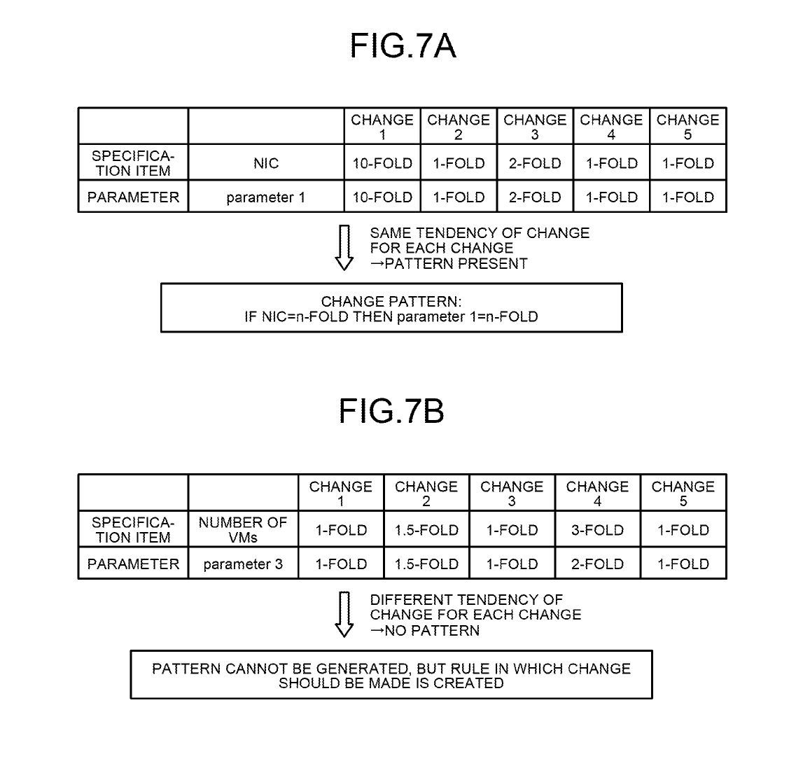

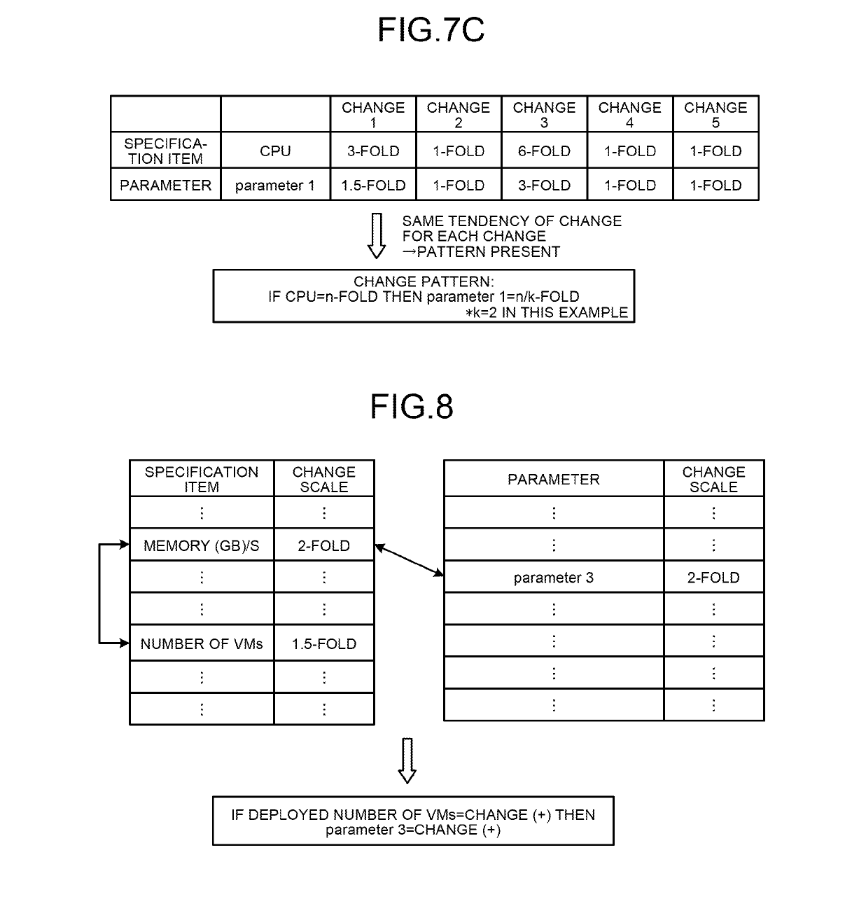

Next, the change-pattern generator 122 in the embodiment will be described with reference to FIGS. 7A to 7C. FIGS. 7A to 7C are diagrams for explaining the change-pattern generator in the embodiment. As illustrated in FIGS. 7A to 7C, illustrated are the change scales for the respective changes in the combination of “related” extracted by the relationship extracting module 121.

The combination illustrated in FIG. 7A is the combination of the specification item of “NIC” and the parameter of “parameter1”. In this combination, the change scales are tenfold each in the change 1, the change scales are twofold each in the change 3, and the change scales in the other changes 2, 4, and 5 are one-fold each. In this combination, because the change ratios in the respective changes are the same, the change-pattern generator 122 calculates, based on the change ratio, a linear function in which the value of the specification item is defined as the X axis and the value of the parameter is defined as the Y axis. Calculated here is a linear function of X=Y. More specifically, it is presumed that there is the same change tendency in the respective changes. Consequently, the change pattern generator 122 generates, by the calculated linear function, a change pattern of the parameter change information corresponding to the specification-item change information. As the linear function here is Y=X, the change pattern is generated as “IF NIC=n-fold THEN parameter1=n-fold”.

The combination illustrated in FIG. 7B is the combination of the specification item of “number of VMs” and the parameter of “parameter3”. In this combination, the change scales are one-and-a-half-fold each in the change 2, but in the change 4, the change scale of the specification item is threefold and the change scale of the parameter is twofold. In this combination, because the change ratios in the respective changes are not the same, the change-pattern generator 122 is unable to calculate a linear function in which the value of the specification item is defined as the X axis and the value of the parameter is defined as the Y axis. More specifically, it is presumed that there are different change tendencies in the respective changes. Consequently, the change-pattern generator 122 does not generate a change pattern, but makes the change-rule generator 123 generate a change rule.

The combination illustrated in FIG. 7C is the combination of the specification item of “CPU” and the parameter of “parameter2”. In this combination, the change scale of the specification item is threefold and the change scale of the parameter is one-and-a-half-fold in the change 1, the change scale of the specification item is six-fold and the change scale of the parameter is threefold in the change 3, and the change scales in the other changes 2, 4, and 5 are one-fold each. In this combination, because the change ratios in the respective changes are the same, the change-pattern generator 122 calculates, based on the change ratio, a linear function in which the value of the specification item is defined as the X axis and the value of the parameter is defined as the Y axis. Calculated here is a linear function of X=Y/2. More specifically, it is presumed that there is the same change tendency in the respective changes. Consequently, the change pattern generator 122 generates, by the calculated linear function, a change pattern of the parameter change information corresponding to the specification-item change information. As the linear function here is Y=X/2, the change pattern is generated as “IF CPU=n-fold THEN parameter2=n/k-fold (in this case, k=2)”.

Next, the change-rule generator 123 in the embodiment will be described with reference to FIG. 8. FIG. 8 is a diagram for explaining the change-rule generator in the embodiment. As illustrated on the left side in FIG. 8, the change scales are indicated for each specification item. More specifically, the specification-item change information for each specification item is indicated for the change 1 (see FIG. 6A), for example. As illustrated on the right side in FIG. 8, the change scales are indicated for each parameter. More specifically, the parameter change information for each parameter is indicated for the change 1 (see FIG. 6A), for example. While the combination of “deployed number of VMs” as the specification item and “parameter3” as the parameter is the combination of “related”, it is assumed here that it is the combination for which the change tendency is not constant.

Under such a condition, the change-rule generator 123 extracts, by using the specification-item change information on each change, two specification items in which neither one of the change scales is one. More specifically, the change-rule generator 123 extracts two specification items that have the tendency of being changed at the same time among the specification items. It is assumed here that two specification items of “Memory (GB)/S” and “deployed number of VMs” are extracted.

Then, if the combination of one specification item, out of the two specification items extracted, and one parameter is the combination that has a change pattern, the change-rule generator 123 generates a change rule by using the parameter and the other specification item. It is assumed here that the combination of “Memory (GB)/S” as the specification item and “parameter3” as the parameter is the combination that has a change pattern.

Then, the change-rule generator 123 generates a change rule by using the parameter of “parameter3” and the other specification item of “deployed number of VMs”. Generated here is the change rule in which, when the specification item of “deployed number of VMs” is changed, the parameter of “parameter3” is changed. Furthermore, when the specification item of “deployed number of VMs” is changed one-and-a-half-fold, or in the positive direction, the parameter of “parameter3” is changed twofold, or in the positive direction. Thus, the change rule is generated as “IF deployed number of VMs=change (+) THEN parameter3=change (+)”.

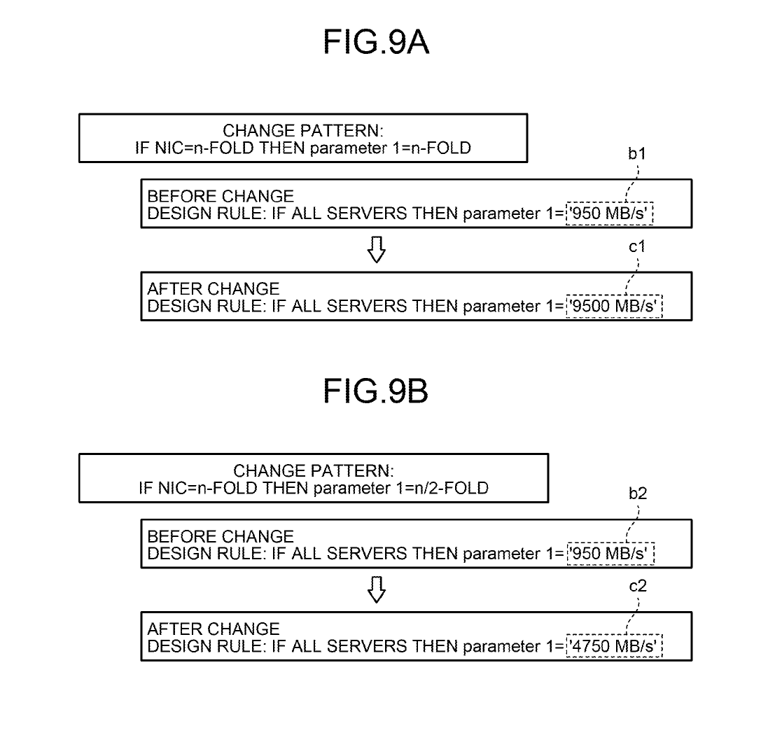

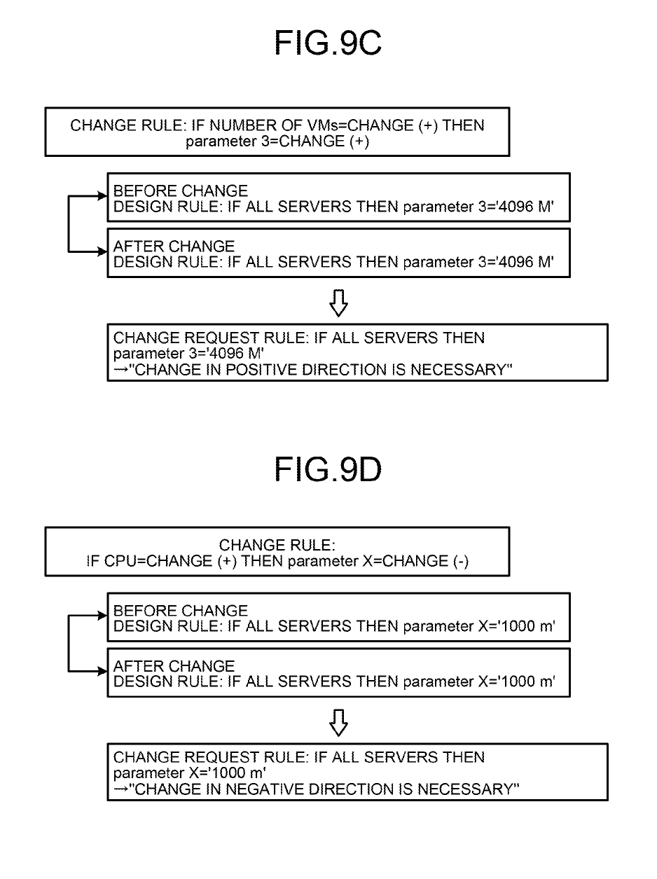

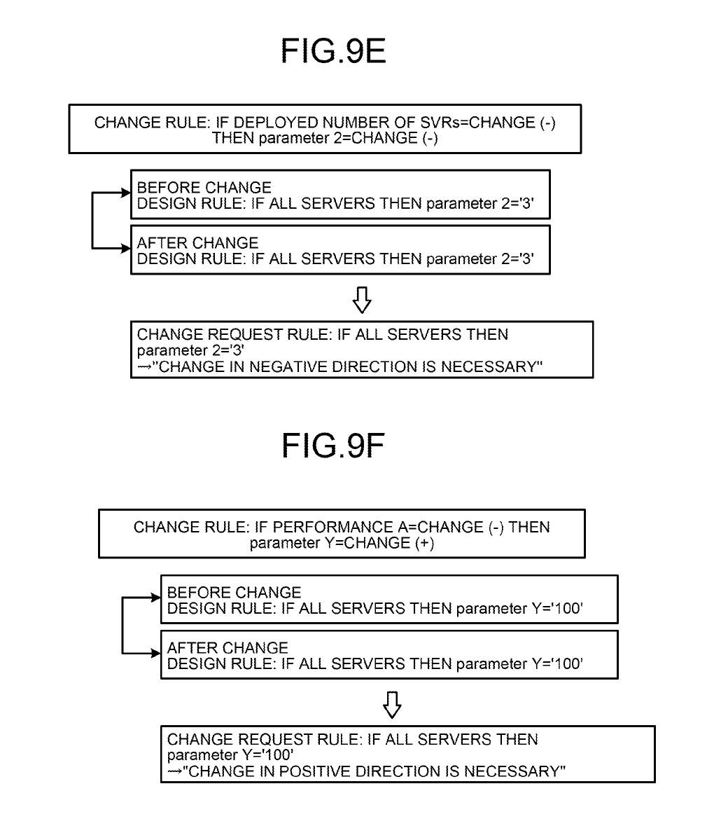

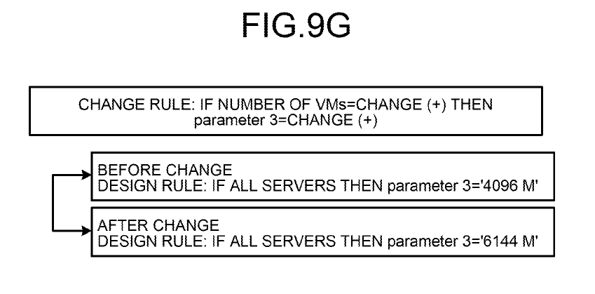

Next, the design-rule change module 124 in the embodiment will be described with reference to FIGS. 9A to 9G. FIGS. 9A to 9G are diagrams for explaining the design-rule change module in the embodiment. FIGS. 9A and 9B explain the situations of changing a design rule by using a change pattern. FIGS. 9C to 9G explain the situations of checking whether an appropriate design rule has been changed by using a change pattern.

In FIGS. 9A and 9B, illustrated are change patterns generated by the change-pattern generator 122 for the combination of the specification item and the parameter. As illustrated in FIG. 9A, the change pattern is as “IF NIC=n-fold THEN parameter1=n-fold”. Now, it is assumed that the specification item “NIC” was changed from 1 GbE to 10 GbE at the time a data center was newly structured, for example. The n in the change pattern is substituted with “10”. Then, the design-rule change module 124 changes the design rule that sets the value of the parameter corresponding to the change pattern by using the change pattern. Here, the value of the “parameter1” parameter of the before-change design rule 113 is “950 MB/s” (b1). The scale of the value of the “parameter1” parameter in the change pattern is tenfold. Consequently, the design-rule change module 124 generates, by using the change pattern, the after-change design rule 114 that changes the value of the “parameter1” parameter to a tenfold “9500 MB/s” (c1).

As illustrated in FIG. 9B, the change pattern is as “IF NIC=n-fold THEN parameter1=n/2-fold”. Now, it is assumed that the specification item “NIC” was changed from 1 GbE to 10 GbE at the time a data center was newly structured, for example. The n in the change pattern is substituted with “10”. Then, the design-rule change module 124 changes the design rule that sets the value of the parameter corresponding to the change pattern by using the change pattern. Here, the value of the “parameter1” parameter of the before-change design rule 113 is “950 MB/s” (b2). The scale of the value of the “parameter1” parameter in the change pattern is fivefold. Consequently, the design-rule change module 124 generates, by using the change pattern, the after-change design rule 114 that changes the value of the “parameter1” parameter to a fivefold “4750 MB/s” (c2).

As illustrated in FIG. 9C, the change rule is as “IF number of VMs=change (+) THEN parameter3=change (+)”. The design-rule change module 124 checks, by using the change rule, whether the after-change design rule 114 has been changed by the relation of the specification item of “number of VMs” and the parameter of “parameter3” which correspond to the change rule. Here, it is assumed that the specification item “number of VMs” was changed from 36 to 54 that was an increase of 18 at the time a data center was newly structured, for example. As for the design rule that corresponds to the change rule, the before-change design rule 113 is as “IF all servers THEN parameter3=‘4096 M’”, and the after-change design rule 114 is as “IF all servers THEN parameter3=‘4096 M’”. Then, the design-rule change module 124 determines that the after-change design rule 114 has not been changed because the value of the “parameter3” parameter is “4096 M” and has not been changed in the positive direction while the specification item of “number of VMs” has been changed in the positive direction. The design-rule change module 124 outputs, for this design rule, a change request stating that “the change in the positive direction is preferable” to an administrator, as one example.

As illustrated in FIG. 9D, the change rule is as “IF CPU=change (+) THEN parameterX=change (−)”. The design-rule change module 124 checks, by using the change rule, whether the after-change design rule 114 has been changed by the relation of the specification item of “CPU” and the parameter of “parameterX” which correspond to the change rule. Here, it is assumed that the performance of the specification item of “CPU” was increased from 1 GHz to 10 GHz at the time a data center was newly structured, for example. As for the design rule that corresponds to the change rule, the before-change design rule 113 is as “IF all servers THEN parameterX=‘1000 m’”, and the after-change design rule 114 is as “IF all servers THEN parameterX=‘1000 m’”. Then, the design-rule change module 124 determines that the after-change design rule 114 has not been changed because the value of the “parameterX” parameter is “1000 m” and has not been changed in the negative direction while the specification item of “CPU” has been changed in the positive direction. The design-rule change module 124 outputs, for this design rule, a change request stating that “the change in the negative direction is preferable” to the administrator, as one example.

As illustrated in FIG. 9E, the change rule is as “IF deployed number of SVRs=change (−) THEN parameter2=change (−)”. The design-rule change module 124 checks, by using the change rule, whether the after-change design rule 114 has been changed by the relation of the specification item of “deployed number of VMs” and the parameter of “parameter2” which correspond to the change rule. Here, it is assumed that the specification item of “deployed number of VMs” was decreased from 126 to 62 at the time a data center was newly structured, for example. As for the design rule that corresponds to the change rule, the before-change design rule 113 is as “IF all servers THEN parameter2=‘3’”, and the after-change design rule 114 is as “IF all servers THEN parameter2=‘3’”. Then, the design-rule change module 124 determines that the after-change design rule 114 has not been changed because the value of the “parameter2” parameter is “3” and has not been changed in the negative direction while the specification item of “deployed number of VMs” has been changed in the negative direction. The design-rule change module 124 outputs, for this design rule, a change request stating that “the change in the negative direction is preferable” to the administrator, as one example.

As illustrated in FIG. 9F, the change rule is as “IF performance A=change (−) THEN parameter Y=change (+)”. The design-rule change module 124 checks, by using the change rule, whether the after-change design rule 114 has been changed by the relation of the specification item of “performance A” and the parameter of “parameter Y” which correspond to the change rule. Here, it is assumed that the specification item of “performance A” was degraded at the time a data center was newly structured, for example. As for the design rule that corresponds to the change rule, the before-change design rule 113 is as “IF all servers THEN parameter Y=‘100’”, and the after-change design rule 114 is as “IF all servers THEN parameter Y=‘100’”. Then, the design-rule change module 124 determines that the after-change design rule 114 has not been changed because the value of the parameter of “parameter Y” is “100” and has not been changed in the positive direction while the specification item of “performance A” has been changed in the negative direction. The design-rule change module 124 outputs, for this design rule, a change request stating that “the change in the positive direction is preferable” to the administrator, as one example.

As illustrated in FIG. 9G, the change rule is as “IF number of VMs=change (+) THEN parameter3=change (+)”. The design-rule change module 124 checks, by using the change rule, whether the after-change design rule 114 has been changed by the relation of the specification item of “number of VMs” and the parameter of “parameter3” which correspond to the change rule. Here, it is assumed that the specification item of “number of VMs” was changed from 36 to 54 that was an increase of 18 at the time a data center was newly structured, for example. As for the design rule that corresponds to the change rule, the before-change design rules 113 is as “IF all servers THEN parameter3=‘4096 M’”, and the after-change design rule 114 is as “IF all servers THEN parameter3=‘6144 M’”. Then, the design-rule change module 124 determines that the after-change design rule 114 has been changed because the specification item of “number of VMs” has been changed in the positive direction and the value of the “parameter3” parameter has been changed in the positive direction from “4096 M” to “6144 M”. Thus, the design-rule change module 124 does not make a change request for this design rule as the change has been made according to the change rule.

Procedure for Design-Rule Change Process

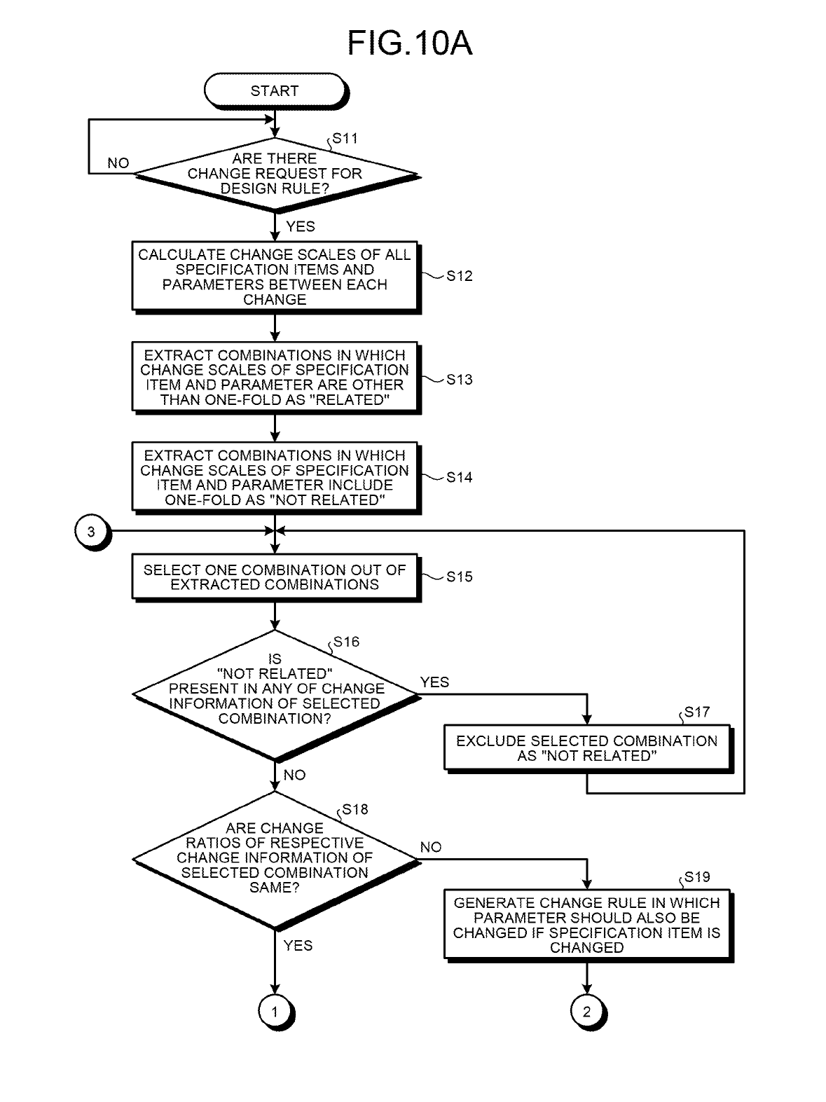

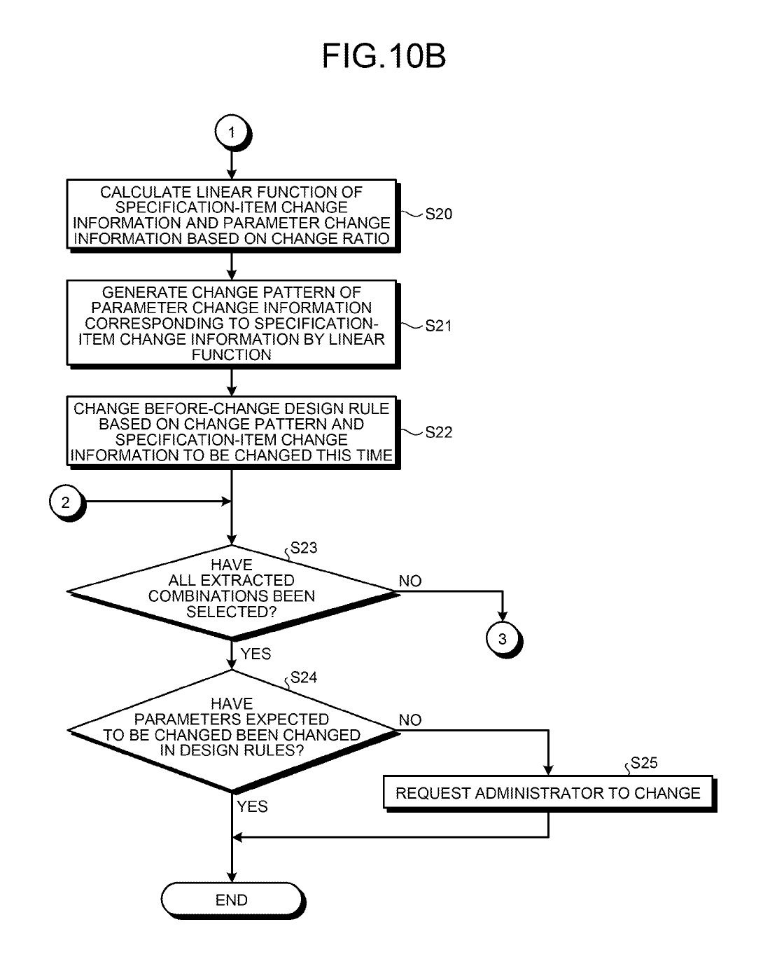

The following describes a procedure for a design-rule change process with reference to FIGS. 10A and 10B. FIGS. 10A and 10B are flowcharts illustrating the design-rule change process performed in the embodiment. It is assumed that there are changes in specification at the time the data center 2 is newly structured, as compared with a data center structured in the past, for example.

The relationship extracting module 121 first determines whether there was a change request for a design rule (Step S11). If there is no change request for a design rule (No at Step S11), the relationship extracting module 121 repeats the determining process until there is a change request for a design rule.

In contrast, if there was a change request for a design rule (Yes at Step S11), the relationship extracting module 121 calculates change scales of all of the specification items and the parameters between the respective changes (Step S12). For example, the relationship extracting module 121 calculates, for the respective changes, a change scale between the same specification items in two pieces of the specification information 111 before and after the change, for each specification item. The specification-item change information is generated for each change and for each specification item. The relationship extracting module 121 then calculates, for the respective changes, a change scale between the same parameters in two pieces of the parameter information 112 before and after the change, for each parameter. The parameter change information is generated for each change and for each parameter.

The relationship extracting module 121 then extracts the combinations in which the change scales of the specification item and the parameter are other than one-fold as “related” (Step S13). For example, the relationship extracting module 121 extracts round robin combinations of the specification-item change information and the parameter change information for the change information on each change. The relationship extracting module 121 then extracts, out of the round robin combinations, the combinations in which neither one of the change scales is one as “related”.

The relationship extracting module 121 then extracts the combinations in which the change scales of the specification item and the parameter include one-fold as “not related” (Step S14). For example, the relationship extracting module 121 extracts, out of the round robin combinations, the combinations in which either one of the change scales of the specification-item change information and the parameter change information is one as “not related”.

Subsequently, the relationship extracting module 121 selects one combination out of the extracted combinations (Step S15).

The relationship extracting module 121 then determines whether the “not related” is present in any of the change information on the selected combination (Step S16). If the “not related” is present in any of the change information on the selected combination (Yes at Step S16), the relationship extracting module 121 excludes the selected combination as “not related” (Step S17).

In contrast, if the “not related” is not present in any of the change information on the selected combination (No at Step S16), the change-pattern generator 122 determines whether the change ratios in the respective change information on the selected combination are the same (Step S18). If the change ratios in the respective change information on the selected combination are not the same (No at Step S18), the change-rule generator 123 generates a change rule that the parameter is also changed if the specification item is changed (Step S19). The procedure is then moved on to Step S23 in order for the change-rule generator 123 to select a subsequent combination.

In contrast, if the change ratios in the respective change information on the selected combination are the same (Yes at Step S18), the change-pattern generator 122 calculates, based on the change ratio, a linear function of the specification-item change information and the parameter change information (Step S20). The change-pattern generator 122 then generates, by the linear function, a change pattern of the parameter change information corresponding to the specification-item change information (Step S21).

Subsequently, the design-rule change module 124 changes the before-change design rule 113, based on the generated change pattern and the specification-item change information on the specification item to be changed this time (Step S22). The design-rule change module 124 then records the changed design rule in the storage module 11 as the after-change design rule 114.

The relationship extracting module 121 then determines whether all of the extracted combinations were selected (Step S23). If all of the extracted combinations were not selected (No at Step S23), the procedure is moved on to Step S15 in order for the relationship extracting module 121 to select a subsequent combination.

In contrast, if all of the extracted combinations have been selected (Yes at Step S23), the design-rule change module 124 determines whether parameters expected to be changed have been changed in the design rules (Step S24). For example, the design-rule change module 124 checks, by using the change rule generated by the change-rule generator 123, whether the after-change design rule 114 has been changed by the relation of the specification item and the parameter which correspond to the change rule.

If the parameters expected to be changed have been changed in the design rules (Yes at Step S24), the design-rule change module 124 ends the design-rule change process.

In contrast, if the parameters expected to be changed have not been changed in the design rules (No at Step S24), the design-rule change module 124 outputs change requests to the administrator (Step S25). The design-rule change module 124 then ends the design-rule change process.

### ADVANTAGEOUS EFFECTS OF EMBODIMENT

In accordance with the foregoing embodiment, the control device 1 extracts, from the change information concerning the specification items of hardware changed in the past and the change information on the parameters set to the hardware, the combinations of the specification-item change information and the parameter change information that are in correlation. The control device 1 calculates a relational expression of the specification-item change information and the parameter change information for each of the extracted combinations. The control device 1 then generates a change pattern of the parameter change information corresponding to the specification-item change information by the calculated relational expression. According to such a configuration, even if there is a change concerning the specification item of the hardware, the use of the generated change pattern enables the control device 1 to automatically change the value of the parameter related to the specification item.

Furthermore, in accordance with the embodiment, the control device 1 extracts, from the specification-item change information and the parameter change information at a plurality of time points of change, the combinations of the specification-item change information and the parameter change information that are in correlation. The control device 1 then calculates, by using the specification-item change information and the parameter change information at each time point of change, a relational expression of the specification-item change information and the parameter change information for each of the extracted combinations. According to such a configuration, calculating a relational expression of the specification-item change information and parameter change information by using the specification-item change information and parameter change information at the time points of change enables an accurate change pattern to be generated.

In accordance with the embodiment, the control device 1 excludes, from the specification-item change information indicative of change scales concerning the specification items and parameter change information indicative of the change scales concerning the parameters at a plurality of time points of change, the combinations in which either one of the change scales is one as having no correlation. According to such a configuration, excluding the combinations in which either one of the change scales is one as having no correlation enables the control device 1 to generate a change pattern promptly.

In accordance with the embodiment, the control device 1 calculates relational expressions for the extracted combinations when the change ratios obtainable from the change scales of the specification-item change information and the change scales of the parameter change information are the same at a plurality of time points of change. According to such a configuration, the control device 1 can reliably calculate the relational expression of the specification-item change information and the parameter change information.

In accordance with the embodiment, the control device 1 executes the following process for the extracted combinations when the change ratios obtainable from the change scales of the specification-item change information and the change scales of the parameter change information are not the same at a plurality of time points of change. That is, the control device 1 requests that, if the value of the specification item concerning the specification-item change information is changed, the value of the parameter concerning the parameter change information is to be changed. According to such a configuration, the control device 1 can function as a check function when the value of the parameter was not changed.

In accordance with the embodiment, the control device 1 changes, by using the generated change patterns and the specification-item change information on the specification items to be changed this time, design rules indicative of the conditions and definitions used for setting the parameters. According to such a configuration, the control device 1 can automatically change the design rules that set the values of the parameters related to the specification items to be changed this time.

Others

In the embodiment, it has been described that, at the time there is a specification change in the newly structured data center 2, for example, the relationship extracting module 121 extracts the combinations of the change information on the specification items and parameters that are in correlation. Then, the change-pattern generator 122 generates a change pattern for each of the combinations extracted by the relationship extracting module 121. The relationship extracting module 121, however, is not limited to this. The relationship extracting module 121 may in advance, before the specification change is made, extract the combinations of the change information on the specification items and parameters that are in correlation, and the change-pattern generator 122 may generate a change pattern for each of the combinations extracted by the relationship extracting module 121.

Furthermore, in the embodiment, it has been described that the change pattern generator 122 calculates, for each of the combinations extracted by the relationship extracting module 121, the change ratios for the change scales of the specification items and the parameters included in the change information on each change. Then, the change-pattern generator 122 selects the combinations one by one, and if the change ratios of the respective changes are the same for the selected combination, calculates a linear function of the specification-item change information and parameter change information based on the change ratio. The change-pattern generator 122, however, is not limited to this. The change-pattern generator 122 may calculate, by using the change information on a single change without using the change information on a plurality of changes, the change ratios for the change scales of the specification items and parameters included in the change. Then, the change-pattern generator 122 only needs to select the combinations one by one and, if the change ratios of the change are the same for the selected combination, calculate a linear function of the specification-item change information and parameter change information based on the change ratio.

Furthermore, the control device 1 can be implemented by installing the functions of the various modules in the foregoing such as the relationship extracting module 121, the change-pattern generator 122, and the change-rule generator 123 on a known information processing apparatus such as a personal computer and a workstation.

The respective constituent elements of the device illustrated in the drawings are not necessarily physically configured as illustrated in the drawings. In other words, the specific embodiments of distribution or integration of the device are not limited to those illustrated, and the whole or a part thereof can be configured by being functionally or physically distributed or integrated in any unit according to various types of loads and usage. For example, the change-pattern generator 122 and the change-rule generator 123 may be integrated as a single module. Meanwhile, the design-rule change module 124 may be distributed to a change module that changes a design rule by using a change pattern, and a checking module that checks whether a design rule has been changed by using a change rule. Moreover, the storage module 11 may be configured to be stored in an external device of the control device 1, or an external device in which the storage module 11 is stored may be connected to the control device 1 via a network.

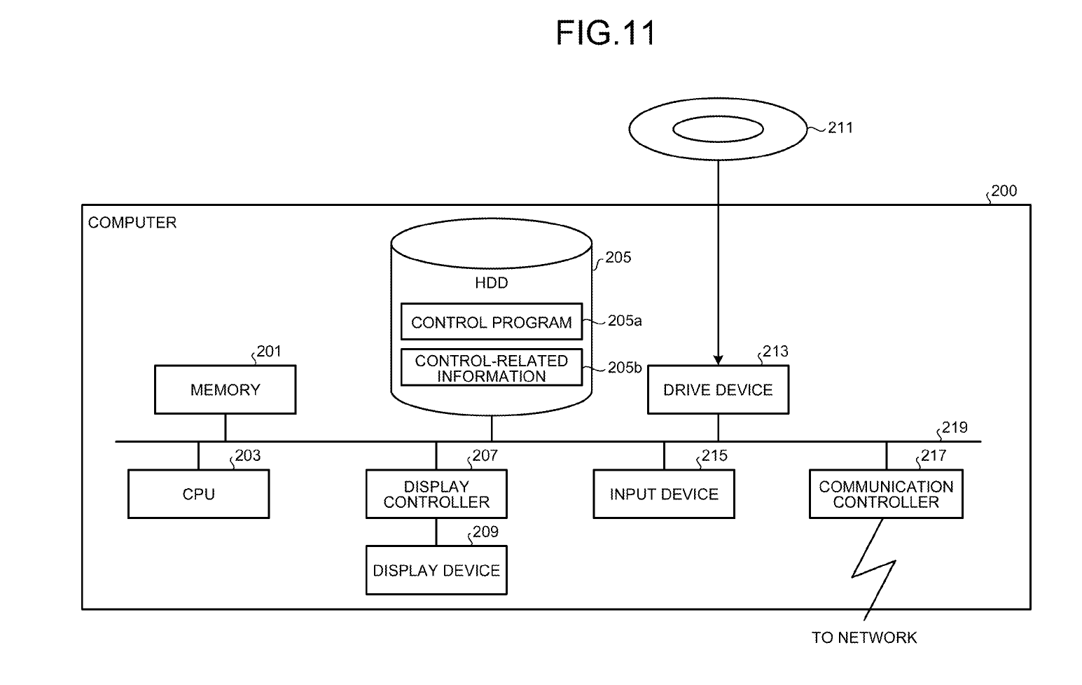

The various processes described in the foregoing embodiment can be implemented by executing a program prepared in advance on a computer such as a personal computer and a workstation. In the following description, explained is an example of a computer that executes a control program which renders the same functions as those of the control device 1 illustrated in FIG. 1. FIG. 11 is a block diagram illustrating an example of a computer that executes the control program.

As illustrated in FIG. 11, a computer 200 includes a CPU 203 that executes a variety of arithmetic processes, an input device 215 that receives data input from a user, and a display controller 207 that controls a display device 209. The computer 200 further includes a drive device 213 that reads out programs and others from a storage medium, and a communication controller 217 that exchanges data with other computers via a network. Furthermore, the computer 200 includes a memory 201 that temporarily stores therein a variety of information, and an HDD 205. The memory 201, the CPU 203, the HDD 205, the display controller 207, the drive device 213, the input device 215, and the communication controller 217 are connected with one another via a bus 219.

The drive device 213 is a device for a removable disk 211, for example. The HDD 205 stores therein a control program 205a and control-related information 205b.

The CPU 203 reads out the control program 205a, loads it onto the memory 201, and executes it as a process. Such a process corresponds to the various function modules of the control device 1. The control-related information 205b corresponds to the specification information 111, the parameter information 112, and the design rules 113 and 114. The removable disk 211 stores therein the respective information such as the specification information 111, for example.

Note that the control program 205a is not necessarily stored in the HDD 205 from the beginning. For example, the program may be stored in a “transportable physical medium” that is inserted to the computer 200 such as a flexible disk (FD), a CD-ROM, a DVD disc, a magneto-optical disk, and an IC card. Then, the computer 200 may be configured to read out the control program 205a from the foregoing and execute it.

In accordance with one aspect of the embodiment, the design rules can be changed automatically even when environmental changes and specification changes are made.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer-readable recording medium storing therein a control program that causes a computer to execute a process comprising:
extracting, from specification-item change information indicative of change information concerning specification items of hardware changed in past and parameter change information indicative of change information concerning parameters set to the hardware, combinations of the specification-item change information and the parameter change information being in correlation;
calculating a relational expression of the specification-item change information and the parameter change information for each of the combinations extracted at the extracting; and
generating a change pattern of the parameter change information corresponding to the specification-item change information by the relational expression calculated at the calculating.

2. The non-transitory computer-readable recording medium according to claim 1, wherein
the extracting extracts combinations of the specification-item change information and the parameter change information being in correlation from the specification-item change information and the parameter change information at a plurality of time points of change, and
the calculating calculates the relational expression of the specification-item change information and the parameter change information for each of the combinations extracted at the extracting by using the specification-item change information and the parameter change information at each time point of change.

3. The non-transitory computer-readable recording medium according to claim 1, wherein the extracting excludes combinations in which either one of change scales is one as not being in correlation from the specification-item change information indicative of change scales concerning specification items and the parameter change information indicative of change scales concerning parameters at a plurality of time points of change.

4. The non-transitory computer-readable recording medium according to claim 3, wherein the calculating calculates the relational expression of the specification-item change information and the parameter change information for the combinations extracted at the extracting when change ratios obtainable from the change scales of the specification-item change information and the change scales of the parameter change information are the same at a plurality of time points of change.

5. The non-transitory computer-readable recording medium according to claim 4, wherein the calculating requests that values of parameters concerning the parameter change information to be changed, when change ratios obtainable from the change scales of the specification-item change information and the change scales of the parameter change information are not the same at a plurality of time points of change and values of specification items concerning the specification-item change information are changed for the combinations extracted at the extracting.

6. The non-transitory computer-readable recording medium according to claim 1, wherein the process further comprises
changing a rule indicative of conditions and definitions used for setting parameters by using the change pattern generated by the generating and the specification-item change information on a specification item to be changed this time.

7. A control device comprising:
a processor; and
a memory, wherein the processor executes:
extracting, from specification-item change information indicative of change information concerning specification items of hardware changed in past and parameter change information indicative of change information concerning parameters set to the hardware, combinations of the specification-item change information and the parameter change information being in correlation;
calculating a relational expression of the specification-item change information and the parameter change information for each of the combinations extracted at the extracting; and
generating a change pattern of the parameter change information corresponding to the specification-item change information by the relational expression calculated at the calculating.

8. A control method executed by a computer, the control method comprising:
extracting, from specification-item change information indicative of change information concerning specification items of hardware changed in past and parameter change information indicative of change information concerning parameters set to the hardware, combinations of the specification-item change information and the parameter change information being in correlation using a processor;
calculating a relational expression of the specification-item change information and the parameter change information for each of the combinations extracted at the extracting using the processor; and
generating a change pattern of the parameter change information corresponding to the specification-item change information by the relational expression calculated at the calculating using the processor.
